(19) United States
(12) Patent Application Publication
(10) Pub. No.: US 2007/0188092 A1
(43) Pub. Date: Aug. 16, 2007

(54) Flexible AC powder electroluminescent lamp and method of manufacturing the same, and moisture resistant phosphor material and method of preparing the same

(75) Inventors: Chang Hwa Lee, Gyeonggi-Do (KR); Tae Hyung Kim, Gyeonggi-Do (KR)

Correspondence Address: MORGAN LEWIS & BOCKIUS LLP, 1111 PENNSYLVANIA AVENUE NW, WASHINGTON, DC, 20004, US

(73) Assignee: Dooco Co., Ltd.

(21) Appl. No.: 11/482,116

(22) Filed: Jul. 7, 2006

(30) Foreign Application Priority Data
Feb. 10, 2006 (KR) 10-2006-0013164

(51) Int. Cl. H01J 1/62

(52) U.S. Cl. 313/511; 313/504

(57) ABSTRACT

The present invention relates to a flexible EL lamp that can extend emission region. In the flexible EL lamp, a phosphor layer, a dielectric layer, and a front electrode layer are exposed to the outside by extending to edge portion of the product. The phosphor layer that is vulnerable to moisture is formed of the phosphor material to which water repellent process is performed. Therefore, the reliability characteristic with respect to moisture can be obtained. The EL lamp can facilitate the design of the compact mobile phones and can improve the reliability of the product.

### CROSS-REFERENCE TO RELATED APPLICATIONS

This application claims the benefit of Korean Patent Application No. 2006-0013164 filed with the Korean Industrial Property Office on Feb. 10, 2006, the disclosure of which is incorporated herein by reference.

### BACKGROUND OF THE INVENTION

1. Field of the Invention

The present invention relates to a flexible electroluminescent (EL) lamp having an extended emission area and good moisture resistance.

2. Description of the Related Art

Recently, EL lamps are widely used as backlight units for keypads of mobile phones. As the mobile phones become slimmer, the use of a light emitting diode (LED) as the backlight unit makes it difficult to decrease the thickness of the mobile phones. Therefore, the LED is being replaced with a thin-film powder EL lamp that is driven with AC power. Hereinafter, this EL lamp will be referred to as an AC powder EL lamp.

The AC powder EL lamp used as the backlight of the mobile phone has very small thickness of about 0.1-0.2 mm and is so flexible as to provide a “clicking” feel when the user presses keys of the mobile phone.

FIG. 1 is a sectional view of an AC powder EL lamp according to the related art. Generally, the EL lamp is manufactured using screen printing. The screen printing uses functional inks to form layers on a transparent base film such as PET film. As illustrated in FIG. 1, a front electrode layer 220 is formed of a transparent conductive material (generally, indium tin oxide (ITO)) on a base film 211 such as a transparent PET film. A phosphor layer 224 and a dielectric layer 226 are formed on the front electrode layer 220. The phosphor layer 224 converts electric energy into light and the dielectric layer 226 supplies electric energy to phosphors. A rear electrode layer 228 is formed on the dielectric layer 226. The rear electrode layer 228 supplies electric energy to the phosphor layer 224 and the dielectric layer 226. A protective layer 230 is formed to cover all the layers. The protective layer 230 is formed using an insulating ink and protects the layers from moisture and shock.

As illustrated in FIG. 1, when AC voltage (generally 100 Vrms-400 Hz) is applied between the front electrode layer 220 and the rear electrode layer 228, light is emitted from the phosphors. Then, the emitted light passes through the PET film to the outside of the EL lamp.

The above-described AC powder EL lamp has been widely used as the backlight unit of the LCD. In recent years, however, the AC powder EL lamp used as the backlight unit for the keypad of the mobile phone has some problems because of a “hard” characteristic of the PET film used as the base film 210.

When the user clicks a key disposed on the keypad of the mobile phone, the clicking of the key is transferred to a dome through the EL lamp disposed under the key. Then, the dome comes in contact with a printed circuit board (PCB) disposed under the dome, so that the clicked key is recognized. In these processes, if the EL lamp has a hard characteristic, it is difficult to transfer the force generated when the key is clicked. Consequently, the clicking feel of the mobile phone is degraded.

To solve this problem, an AC powder EL lamp having a flexible characteristic has been recently developed and marketed. This EL lamp will be referred to as a flexible EL lamp. In the flexible EL lamp, a front protective layer instead of the transparent front electrode is formed on the PET film using a flexible film (generally, a urethane film) or a transparent insulating ink. Then, the other layers are printed, thereby completing the formation of the EL lamp. After the PET film (i.e., the base film 211) is removed, the EL lamp is used. Therefore, the EL lamp is very flexible because it does not include the base film 211 (e.g., the PET film) having a hard characteristic. If the flexible EL lamp is applied to the keypad of the mobile phone, a very excellent clicking feel can be obtained. A structure of a flexible EL lamp according to the related art is illustrated in FIGS. 2A and 2B.

Hereinafter, a flexible EL lamp and a method of manufacturing the same according to the related art will be described with reference to FIGS. 2A and 2B.

Referring to FIGS. 2A and 2B, a front protective layer 212 is formed on a PET film (generally, 100-150 μm) used as a base film 211. The front protective layer 212 may be a transparent insulating ink layer or a urethane film having good flexibility and resilience. At this point, the base film 211 must be able to be easily lifted off. For this purpose, when the front protective layer 212 is formed, an adhesion process is carried out on the surface of the PET film, or a silicon-based additive is added to the transparent insulating ink. Next, a front electrode layer 220 is formed on the front protective layer 212 using an ink for a transparent electrode (generally, an ITO ink or a conductive polymer ink). Subsequent processes are identical to those of the typical AC powder EL lamp.

A front bus bar layer 222a and a rear bus bar layer 222b are formed using a material having good conductivity, for example, a silver ink. The bus bar layer increases the uniformity of an emission state by evenly transferring electric energy supplied from a terminal over all emission regions of the EL lamp. A portion of the bus bar layer is exposed out of the rear protective layer 230 and the exposed portion acts as a terminal part that can be connected to an external power source. All regions of the bus bar layer other than the terminal part are surrounded by the rear protective layer 230.

A difference between the flexible EL lamp and the typical AC powder EL lamp is that the base film 211 is removed and all regions of the EL lamp are surrounded by the front protective layer 212 and the rear protective layer 230. In the case of the typical AC powder EL lamp (see FIG. 1), because the front electrode layer 220 is connected up to the outside of the protective layer 230, it is exposed at a cut boundary of the product. However, in the case of the flexible EL lamp, all of the front electrode layer 220, the phosphor layer 224, the dielectric layer 226, and the rear electrode layer 228 are surrounded by the front protective layer 212 and the rear protective layer 230. The front electrode layer 220, the phosphor layer 224, the dielectric layer 226, and the rear electrode layer 228 are substantially associated with the light emission. These layers (especially, the phosphors contained in the phosphor layer) are vulnerable to moisture. Therefore, in order to protect the layers from moisture existing in an external environment, the front protective layer and the rear protective layer are formed using materials having good moisture resistance and insulating properties, such that they surround the layers.

In order to secure the reliability of the flexible EL lamp, a structure of the protective layer is very important. In addition to a region where light is actually emitted (an inner region defined by dotted lines, in which the front electrode layer 220, the phosphor layer 224, the dielectric layer 226, and the rear electrode layer 228 are present), a protective layer region for securing the reliability is essentially necessary. In this case, however, a predetermined edge portion of the product cannot be used as the emission region.

In the mobile phones being developed, specifications and characteristics of the parts used in the mobile phone for the slim and compact structure and various functions are required to be changed. Therefore, the keypads of the mobile phones also tend to be slim and compact.

However, because the conventional flexible EL lamp needs a non-emission region so as to secure the reliability of product, there is a limitation in obtaining the compactness of the keypad in the mobile phone.

Specifically, the phosphor layer is most vulnerable to moisture. Therefore, if the phosphor layer is exposed to the outside without being sealed by the protective layer, it is fatal to the reliability of product. Therefore, a surface treatment is carried out on the surfaces of the phosphor particles. Generally, the phosphor of the AC powder EL lamp is formed of a coating phosphor in which the surface of a metal compound (e.g., ZnS compound) is coated with a metal oxide (e.g., silica or alumina).

However, a sufficient moisture resistance required as a component of the mobile phone cannot be obtained through the coating of the metal oxide. Even the AC powder EL lamp using the coated phosphor merely obtains the reliability through the sealing with the protective layer having good moisture resistance.

### SUMMARY OF THE INVENTION

An advantage of the present invention is that it provides a flexible EL lamp and a method of manufacturing the same. In the flexible EL lamp, an emission region is expanded by reducing or removing a non-emission region of the EL lamp, that is, a protective layer region completely surrounding a front electrode layer, a phosphor layer, a dielectric layer, a rear electrode layer, and a line layer.

Another advantage of the present invention is that it provides a phosphor material and a method of preparing the same. The phosphor material is used in the EL lamp and can secure the reliability of an AC powder EL lamp.

Additional aspect and advantages of the present general inventive concept will be set forth in the description which follows and, in part, will be obvious from the description, or may be learned by practice of the general inventive concept.

According to an aspect of the invention, a method of manufacturing a flexible EL lamp includes: forming a front electrode layer (220) on a support layer (210), the support layer (210) including a base film (211) that is formed of a PET film and a front protective layer (212) that is releasable from the base film (211); forming a front bus bar layer (222a) and a phosphor layer (224) on the front electrode layer (220), and sequentially forming a dielectric layer (226), a rear electrode layer (228), and a rear bus bar layer (222b) on the phosphor layer (224); forming a rear protective layer (230) on the resulting structure formed on the support layer (210), such that predetermined portions of both ends of the phosphor layer (224), the dielectric layer (226), and the front electrode layer (220) are exposed without being sealed by the rear protective layer (230); and forming a stepped portion by etching the rear protective layer (230) formed on the front and rear bus bar layers (222a, 222b).

According to another aspect of the present invention, a flexible EL lamp includes: a front electrode layer (220) formed on a front protective layer (212); a front bus bar layer (222a) and a phosphor layer (224) formed on the front electrode layer (220); a dielectric layer (226) formed on the phosphor layer (224); a rear electrode layer (228) formed on the dielectric layer (226); a rear bus bar layer (222b) formed on the rear electrode (228); and a rear protective layer (230) formed on the rear electrode layer (228) and the rear bus bar layer (222b). At this point, predetermined portions of both ends of the front electrode layer (220), the phosphor layer (224), and the dielectric layer (226) are exposed without being sealed by the rear protective layer (230).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view of an AC powder EL lamp according to the related art;

FIG. 2A is a sectional view of a flexible EL lamp according to the related art;

FIG. 2B is a sectional view illustrating an operation of the flexible EL lamp according to the related art;

FIG. 3 is a sectional view of a flexible EL lamp according to an embodiment of the present invention; and

FIG. 4 is a sectional view illustrating emission regions of the flexible EL lamps according to the related art and the present invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

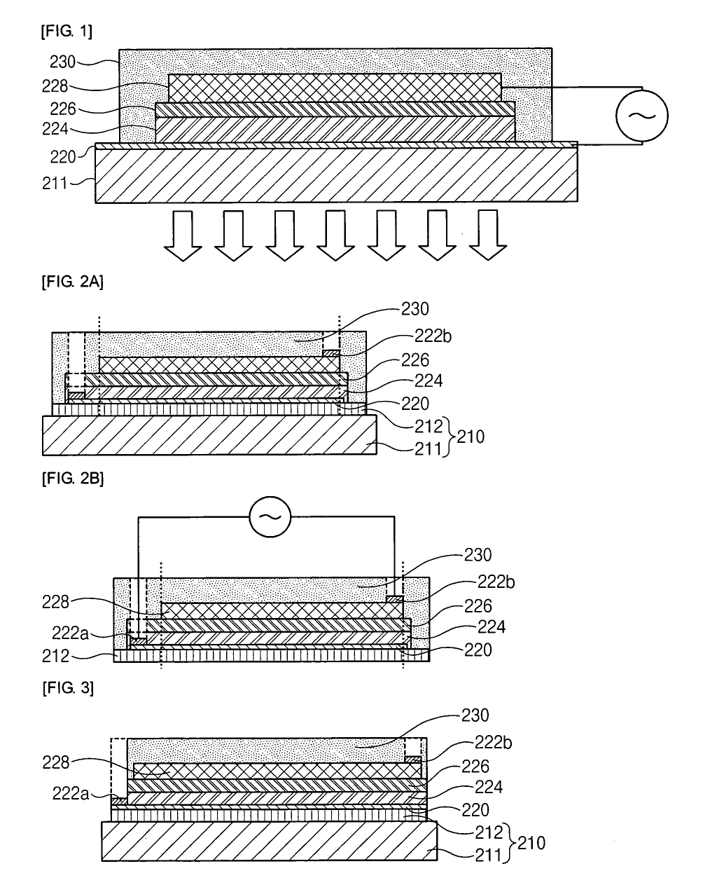

FIG. 3 is a sectional view of a flexible EL lamp according to an embodiment of the present invention. A stacked structure of layers is equal to that of the conventional flexible EL lamp. A release coating is performed on a base film 211 formed of a PET film. Thereafter, a front protective layer 212 such as a urethane film is formed on the base film 211. Next, a front electrode layer 220, a front bus bar 222a, a phosphor layer 224, a dielectric layer 226, a rear electrode layer 228, a rear bus bar layer 222b, and a protective layer 230 are formed in sequence. After the base film 211 is removed, the flexible EL lamp is used.

In the flexible EL lamp according to the present invention, the phosphor layer 224 having phosphors is not completely sealed by the rear protective layer 230. To expand the emission region, the emission layer 224, the dielectric layer 226, and the front electrode layer 220 are formed up to an edge portion of the product without being completely sealed by the front and rear protective layers 212 and 230.

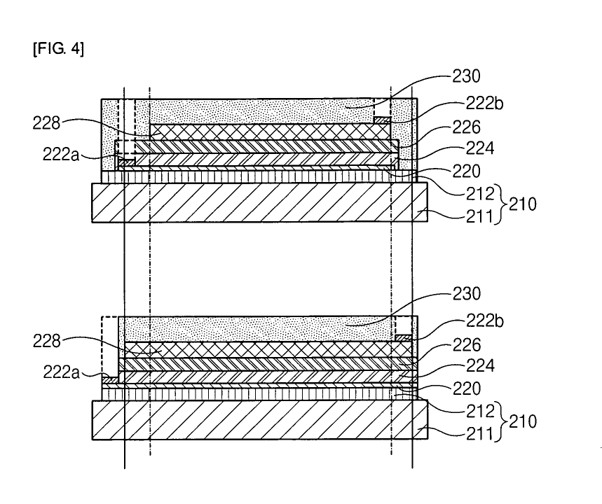

In such a flexible EL lamp, a ratio occupied by the emission region increases. FIG. 4 is a sectional view illustrating the emission regions of the flexible EL lamps according to the related art and the present invention. It can be seen from FIG. 4 that the emission region of the present invention (which is indicated by a solid line) is extended compared with the emission region of the related art (which is indicated by a dotted line).

In order to obtain the reliability characteristic, the protective layer region for sealing the phosphor layer and the dielectric layer must be more than 0.5 mm. According to the present invention, an emission region of 1 (mm)×1 (mm) can be additionally obtained. Therefore, the design of the compact mobile phone becomes convenient and the reliability characteristic of the EL lamp can be improved.

Preferably, the front electrode layer 220 is formed up to the edge portion of the front protective layer 212, and the rear protective layer 230 is formed up to the edge portions of the phosphor layer 224 and the dielectric layer 226.

Furthermore, the present invention provides a phosphor material used in the phosphor layer of the flexible EL lamp in which silicon compound is coated.

In the flexible EL lamp 224 according to the present invention, the phosphor layer 224, the dielectric layer 226, and the front electrode layer 220 are exposed at the edge portion of the product, so that the protective ink of the protective layers 212 and 230 does not completely protect the product from moisture. Meanwhile, the phosphor coated with metal oxide is most vulnerable to moisture. Therefore, the reliability characteristic with respect to moisture can be obtained by performing a water repellent coating on the phosphor.

The phosphor coated with metal compound is a coating phosphor formed by coating the surface of ZnS compound with metal compound such as silica or alumina. For the water repellent process of the phosphor, the phosphor particles are coated using fluorine compounds (fluorine monomer, fluorine-based oligomer, fluorine polymer resin, or fluorine surfactant), hydrocarbon compounds, chloride compounds, or silicon compounds.

In this embodiment, silicon compounds are used as surface treatment material for the phosphor particles. Specifically, silicon oil, silane, or silane coupling agent is used as the silicon compounds.

The silicon oil is used as water repellent, surface-treatment agent, or anti-foaming agent. Examples of the silicon oil may include poly(dimethysiloxane) (PDMS), methylhydrogen polysiloxane, and so on.

Examples of silane may include alkoxysilane (e.g., tetramethoxysilane, tetraethoxysilane) and alkylalkoxysilane (e.g., methyltrimethoxysilane, octyltriethoxysilane).

The silane coupling agent has more than two different radicals. One of them is a radical (e.g., methoxy radical, ethoxy radical, etc.) to be chemically combined with inorganic material, and another is a radical (e.g., synthetic resins) to be chemically combined with organic material. According to the present invention, the silane coupling agent may have vinyl group, epoxy group, amino group, or acryl group according to kinds of the radical combined with the organic material. For example, β-(3,4-epoxycyclohexy)-ethyltrimethoxysilane, 3-metaacryloxypropyl trimethoxysilane, and N-β(aminoethyl)-aminopropyltriethoxysilane, or vinyltrichlorosilane, may be used.

In order for a better water repellent property, fluorine alkyl compounds containing CF₃ and CF₂ within molecules may be included. Examples of there materials may include fluoride silane such as fluoric alkyl silane.

The present invention provides a method of preparing phosphor material that is agitated in a 0.007-0.07-M silicon compound solution.

In addition, the phosphor material is agitated in a silicon compound solution in which a mole ratio of material/silicon compound is 250-1500.

A water repellent process of the phosphor will be described below in detail.

First, a predetermined amount of silicon compound is agitated in a predetermined amount of organic solvent. The organic solvent must be able to dissolve/disperse the silicon compound and must not change characteristics of particles to be surface-treated with the silicon compound. In addition, the organic solvent must have a proper boiling point such that residual components do not remain. A preferred material includes saturated hydrocarbon-based solvent, aromatic hydrocarbon-based solvent, alcoholic solvent, ketonic solvent, or ether solvent.

Preferably, the silicon compound solution for the water repellent coating process on the surface of the phosphor particle has concentration of 0.007-0.7 M. The phosphor does not exhibit satisfactory water resistance below this concentration. In addition, agglomeration of the phosphor particles strongly occurs above this concentration, so that an average particle size greatly increases after the water repellent process. When the screen printing is performed after the preparation of a fluorescent paint necessary for printing the phosphor layer, the increased average particle size may cause a print failure or a non-uniformity of brightness after the manufacture of the product. In addition, silicon compound of excessive concentration has a trouble with the resin material that is a component of the fluorescent paint, causing a secondary agglomeration of the phosphor particles or degradation of dispersion.

An amount of the silicon compound must be sufficient enough to cover the surface of particles to be surface-treated with more than monomolecular layer. Generally, a mole ratio of particle to be surface-treated/silicon compound is 100-10,000.

Specifically, when the surface treatment is performed using silane or silane coupling agent, a predetermined amount of water is added for hydrolysis. In addition, a predetermined amount of acid is added for a proper pH that is suitable for the hydrolysis. However, when the solvent contains water, the addition of water is unnecessary.

The surface of the phosphor particle is coated using a coating solution where the hydrolysis is completed.

After the surface treatment reaction is completed, the phosphor and the solvent are separated using a centrifuge or a sieve and then a remaining solvent is dried and removed. The temperature of the drier must be close to the boiling point of the solvent. In addition, the emission characteristic of the phosphor particle must not be degraded at the temperature. It is preferable that a drying time is more than 12 hours.

Furthermore, it is preferable that the sieve having a proper mesh size be used after the final drying, because there is a great probability that the particles surface-treated during the drying process will be agglomerated. This is advantageous to stabilizing the dispersion in the manufacture of the paint and improving the printing property.

Because the water-repellent phosphor completely blocks moisture by means of the coating layer, the EL lamp can have good reliability characteristic even when the layers are exposed out of the protective layer. Furthermore, the dispersion is improved in the preparation of the fluorescent paint according to the interface characteristic of the water repellent material coated on the surface of the phosphor. Therefore, high-quality fluorescent paint can be prepared and the brightness and electrical characteristic of the final product can be improved.

Hereinafter, the present invention will be described in detail. However, the present invention is not limited to the description herein.

### Embodiment 1

(1) Water Repellent Process of Phosphor Material

First, 300-ml isopropyl alcohol, 0.16-ml distilled water, and 0.01-g citric acid were added in a beaker and were agitated using a mechanical agitator for 10 minutes.

Then, 1-ml 3-metaacryloxypropyl trimethoxysilane, a silane coupling agent, was added and strongly agitated for 30 minutes. In this manner, hydrolysis was performed to prepare the coating solution. Next, while agitating the solution continuously, 90-g phosphor (produced by Oslam Sylvania, Product Name: GG64) was gradually added for 3-5 minutes and then was further agitated for 1 hour.

Then, the phosphor and the solvent were separated using a sieve having 300 meshes, and then were dried at 110° C. for 12 hours in a vacuum drier. Finally, the dried phosphor was again separated using a sieve having 270 meshes, so that the phosphors agglomerated during the drying process were removed.

(2) Preparation of Flexible EL Lamp

A silicon layer was formed on a PET film as a base film 211. The PET film has a size of 450 mm×500 mm and a thickness of 120 μm. A front protective layer 212 was formed by forming a polyurethane layer on the silicon layer using an extrusion process while heating the silicon layer. The base film 211 and the front protective layer 212 serve as a support layer 210. Next, a front electrode layer 220 was formed on the front protective layer 212 up to an edge portion of the front protective layer 212 by screen-printing ITO ink. All subsequent layers were formed using screen printing.

Then, as illustrated in FIG. 3, a phosphor layer 224 was formed using the fluorescent paint, which was made using the water-repellent phosphor, while leaving a predetermined portion of one edge on the front electrode layer 220. A dielectric layer 226 was formed on the phosphor layer 224 by preparing a dielectric paint that uses barium titanate and fluorine-based resin as a coupling agent. Next, a rear electrode layer 228 was formed on a portion of the dielectric layer 226 using a paint containing carbon (graphite). A front bus bar layer 222a was formed on the front electrode layer 220 where the phosphor layer 224 is not formed. Simultaneously, a rear bus bar layer 222b was formed on a portion of the rear electrode layer 228 using a paint containing silver (Ag). Thereafter, a protective layer 230 was formed on the rear electrode layer 228 using screen printing. The rear protective layer 230 was etched to expose the upper portions of the front and rear bus bar layers 222a and 222b, thereby forming a terminal portion.

### Embodiment 2

The second embodiment is identical to the first embodiment, except that the water repellent process is performed on the phosphor particle using isopropyl alcohol, distilled water, acetic acid, and tridecaflurooctyltriethoxysilane as the coating solution. Furthermore, the EL lamp was manufactured using the phosphor material in the same method as the first embodiment.

### Embodiment 3

The third embodiment is identical to the first embodiment, except that the water repellent process is performed on the phosphor particle using isopropyl alcohol and polydimethylsiloxane as the coating solution. Furthermore, the EL lamp was manufactured using the phosphor material in the same method as the first embodiment.

### Comparative Example

An EL lamp was manufactured using phosphor material, to which water repellent process was not performed, in the same method as the first embodiment.

[Test for Moisture Resistance and Reliability Characteristic]

The moisture resistance and reliability characteristic of the phosphors was compared and scrutinized using two experiments.

In the first test for inspecting moisture resistance of the phosphor, the phosphors of the first, second and third embodiments, and the phosphors of the comparative example prepared by coating the surface of ZnS compounds with metal oxide such as silica or alumina are added into a predetermined amount of water. Then, wetness of the phosphors with respect to water was visually observed for 96 hours at every 24 hours. The effect of the water repellent coating could be confirmed from the sinking degree when the phosphors were wetted with water.

In the second test, the flexible EL lamps manufactured according to the first, second and third embodiments and the comparative example were driven by power (100 Vrms-400 Hz) in high-temperature high-humidity environment (60° C. 95% R.H), and the deformation of the products were observed. To confirm the test result, non-emission region formed by moisture penetration or dark spots (point-shaped non-emission region) were observed in the EL lamps.

The results of the two tests are as follows:

| | | Test 2 | |
|---|---|---|---|
| | Test 1 | (High-temperature high- | |
| Specimen | (Wetting test) | humidity driving test) | Result |
| Embodiment 1 | No sinking | Normal | OK |
| Embodiment 2 | No sinking | Normal | OK |
| Embodiment 3 | No sinking | Normal | OK |
| Comparative | Sank after 24 hours | Moisture penetration at | OK |
| Example | | edges of product | |

It can be seen from the results that the water-repellent phosphors according to the first, second and third embodiments are not wetted for 96 hours even when they are placed in water. Therefore, the phosphors were floating without sinking. On the other hand, the phosphor coated with only a metal oxide in the comparative example was wetted and sank.

In addition, in the results of the high-temperature high-humidity driving test, the phosphors of the first, second and third embodiments were not deformed by moisture. However non-emission regions were formed by moisture penetrated from the edges of the EL lamp.

The flexible EL lamp according to the present invention can obtain the extended emission region by extending the phosphor layer and the dielectric layer up to the edge of the product.

In addition, the surface of the phosphor is coated with the metal oxide for improving moisture resistance and lifetime, and the water repellent process is performed on the surface of the phosphor. Therefore, the EL lamp is completely protected from moisture of the external environment. Consequently, the flexible EL lamp according to the present invention can exhibit good reliability characteristic even when the it is not sealed by the protective layer.

The EL lamp can facilitate the design of the compact mobile phones and can improve the reliability of the product.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a flexible electroluminescent (EL) lamp, comprising:
forming a front electrode layer on a support layer, the support layer including a base film that is formed of a PET film and a front protective layer that is releasable from the base film;
forming a front bus bar layer and a phosphor layer on the front electrode layer, and sequentially forming a dielectric layer, a rear electrode layer, and a rear bus bar layer on the phosphor layer;
forming a rear protective layer on the resulting structure formed on the support layer, such that predetermined portions of both ends of the phosphor layer, the dielectric layer, and the front electrode layer are exposed without being sealed by the rear protective layer; and
forming a terminal portion by etching the rear protective layer formed on the front and rear bus bar layers.

2. A flexible EL lamp manufactured by the method according to claim 1, comprising:
a front electrode layer formed on a front protective layer;
a front bus bar layer and a phosphor layer formed on the front electrode layer;
a dielectric layer formed on the phosphor layer;
a rear electrode layer formed on the dielectric layer;
a rear bus bar layer formed on the rear electrode; and
a rear protective layer formed on the rear electrode layer and the rear bus bar layer,
wherein predetermined portions of both ends of the front electrode layer, the phosphor layer, and the dielectric layer are exposed without being sealed by the rear protective layer.

3. The flexible EL lamp according to claim 2,
wherein the front electrode layer is formed up to an edge portion of the front protective layer, and the rear protective layer is formed up to edge portions of the phosphor layer and the dielectric layer.

4. A phosphor material for use in the formation of the phosphor layer,
wherein the phosphor layer is coated with silicon compounds.

5. The phosphor material according to claim 4,
wherein the silicon compounds are silicon oil, silane, or silane coupling agent.

6. The phosphor material according to claim 5,
wherein the silicon oil is poly(dimethysiloxane) (PDMS) or methylhydrogen polysiloxane.

7. The phosphor material according to claim 5,
wherein the silane is alkoxysilane or alkylalkoxysilane.

8. The phosphor material according to claim 5,
wherein the silane coupling agent includes alkoxy group as a radical chemically combined with inorganic material, and vinyl group, epoxy group, amino group, or acryl group as a radical chemically combined with organic material.

9. The phosphor material according to claim 8,
wherein the silane coupling agent is β-(3,4-epoxycyclohexy)-ethyltrimethoxysilane, 3-metaacryloxypropyl trimethoxysilane, and N-β(aminoethyl)-aminopropyltriethoxysilane, or vinyltrichlorosilane.

10. The phosphor material according to claim 4,
wherein the silicon compounds include fluorine alkyl compounds.

11. A method of preparing the phosphor material according to claim 4,
wherein the phosphor material is agitated in 0.007-0.07-M silicon compound solution.

12. A method of preparing the phosphor material according to claim 4,
wherein the phosphor material is agitated in a silicon compound solution in which a mole ratio of phosphor material/silicon compound is 250-1500.
